(19) United States
(12) Patent Application Publication
(10) Pub. No.: US 2025/0326896 A1
(43) Pub. Date: Oct. 23, 2025

(54) Polysiloxane-Polycarbonate Block Co-Condensates Composed of Specially Terminated Siloxane Blocks

(71) Applicant: Covestro Deutschland AG, Leverkusen (DE)

(72) Inventors: Alexander Meyer, Düsseldorf (DE); Ulrich Liesenfelder, Bergisch Gladbach (DE); Lukas Fabian Schulz, Lemgo (DE); Thomas Pfingst, Tönisvorst (DE); Sebastian Wetzel, Schwelm (DE)

(21) Appl. No.: 18/866,381

(22) PCT Filed: May 9, 2023
(86) PCT No.: PCT/EP2023/062220

§ 371 Date: Nov. 15, 2024

(30) Foreign Application Priority Data
May 17, 2022 (EP) 22173805.7

(51) Int. Cl. C08G 77/448; C08G 77/38

(52) U.S. Cl. CPC C08G 77/448; C08G 77/38

(57) ABSTRACT

The present disclosure relates to a process for producing polysiloxane-polycarbonate block co-condensates using specially terminated polysiloxanes, to polysiloxane-polycarbonate block co-condensates having at least one Si—O—C bond and fine siloxane domains, to a moulding compound including the polysiloxane-polycarbonate block co-condensate, to a moulded part containing the polysiloxane-polycarbonate block co-condensate, to the use of a special bisphenol as a terminating group of a polysiloxane to increase the reactivity of the polysiloxane and to the use of a specially terminated polysiloxane in the production of a polysiloxane-polycarbonate block co-condensate to increase the proportion of covalent bonds between the siloxane blocks and the polycarbonate blocks.

### CROSS-REFERENCE TO RELATED APPLICATIONS

This application is the United States national phase of International Patent Application No. PCT/EP2023/062220 filed May 9, 2023, and claims priority to European Patent Application No. 22173805.7 filed May 17, 2022, the disclosures of which are hereby incorporated by reference in their entireties.

### BACKGROUND

### Technical Field

The present invention relates to a process for producing polysiloxane-polycarbonate block co-condensates (also referred to below as SiCoPC) using specially terminated polysiloxanes, to polysiloxane-polycarbonate block co-condensates having at least one Si—O—C bond and fine siloxane domains, to a moulding compound comprising the polysiloxane-polycarbonate block co-condensate according to the invention, to a moulded part containing the polysiloxane-polycarbonate block co-condensate according to the invention, to the use of a special bisphenol as a terminating group of a polysiloxane to increase the reactivity of the polysiloxane and to the use of a specially terminated polysiloxane in the production of a polysiloxane-polycarbonate block co-condensate to increase the proportion of covalent bonds between the siloxane blocks and the polycarbonate blocks.

### Description of Related Art

It is known that polysiloxane-polycarbonate block co-condensates exhibit good properties in terms of low-temperature impact strength/low-temperature notched impact strength, chemicals resistance and exterior weathering resistance as well as aging characteristics and fire resistance. They are in some cases superior to conventional polycarbonates (for example bisphenol A-based homopolycarbonate) in terms of these properties.

These co-condensates are normally industrially produced from the monomers by the interfacial process with phosgene. The production of these polysiloxane-polycarbonate block co-condensates by the melt transesterification process using diphenyl carbonate is also known. These processes have the disadvantage that the industrial plants used therefor are used for producing standard polycarbonate and therefore have a large plant size. The production of special block co-condensates is often not economically viable in these plants due to the smaller volume of these products. Furthermore, the input materials required for producing the co-condensates, for example the polydimethylsiloxanes, can impair the plant since they can lead to contamination of the plant or the solvent circuits. Production moreover requires difficult-to-handle input materials such as phosgene or entails high energy demands such as in the melt transesterification process.

The production of polysiloxane-polycarbonate block co-condensates by the interfacial process is known from the literature and is described for example in U.S. Pat. Nos. 3,189,662, 3,419,634, DE-A 3 34 782, US 2008/0081893A1 and EP 0 122 535.

Production of polysiloxane-polycarbonate block co-condensates by the melt transesterification process from bisphenol, diaryl carbonate, silanol-end-terminated polysiloxanes and catalyst is described in U.S. Pat. No. 5,227,449. The siloxane compounds employed are polydiphenyl/polydimethylsiloxane telomers with silanol end groups. However, it is known that in contrast to diphenylsiloxane having silanol end groups such dimethylsiloxanes having silanol end groups have an increasing propensity for autocondensation in the acidic or basic medium with decreasing chain length, and therefore incorporation into the resulting copolymer is thus impeded. Cyclic siloxanes thus formed remain in the polymer and are extraordinarily disruptive in applications in the electrical/electronics sector.

U.S. Pat. No. 5,504,177 describes the production of a polysiloxane-polycarbonate block co-condensate by melt transesterification from a carbonate-terminated silicone with bisphenol and diaryl carbonate. The great incompatibility of the siloxanes with bisphenol and diaryl carbonate has the result that uniform incorporation of the siloxanes into the polycarbonate matrix via the melt transesterification process is achievable only with great difficulty, if at all.

Disadvantages of all these processes include the use of organic solvents in at least one step of the synthesis of the polysiloxane-polycarbonate block co-condensates or the use of phosgene as an input material or the inadequate quality of the co-condensate. In particular, the synthesis of the co-condensates from the monomers is very costly and complex both in the interfacial process and especially in the melt transesterification process. Thus, melt processes for example must employ a light vacuum and low temperatures to prevent evaporation and thus removal of the monomers. Only in later reaction stages in which oligomers having higher molar masses have formed can lower pressures and higher temperatures be employed. This means that the reaction must be run as a multistage process, with the result that the reaction times are correspondingly long.

Reactive extrusion processes for producing siloxane-based block copolycarbonates have also been described in order to avoid the abovedescribed disadvantages. This has been publicized for example in U.S. Pat. Nos. 5,414,054 and 5,821,321. This comprises reacting a conventional polycarbonate with a special polydimethylsiloxane in a reactive extrusion process. However, the disadvantage of this process is the use of special silicone components which are costly. This process moreover employs highly active transesterification catalysts which enable production of the co-condensates in an extruder over short residence times. However, these transesterification catalysts remain in the product and can be inactivated only insufficiently, if at all. Injection moulded articles made of the thus-produced co-condensates therefore exhibit inadequate aging characteristics, especially inadequate heat aging characteristics. The resulting block copolycarbonate is thus not suitable for high-quality applications. Compared to a block copolycarbonate from the interfacial process this product does not exhibit the appropriate properties, such as aging characteristics and mechanical properties.

Siloxane blocks of the prior art often have Si—C bonds. In the context of the present invention, the terms “Si—C bond” and/or “Si—O—C bond” preferably refer to polysiloxanes having a termination. This termination is preferably an organic radical having a phenolic OH group. This organic radical having a phenolic OH group is preferably bonded via an Si—C bond or an Si—O—C bond. It may also be the case that an Si—C bond and/or an Si—O—C bond is present at another site in the polysiloxane. However, it is preferable when this refers at least to the linkage of the end group (terminating group) to the siloxane group.

The Si—C bonds are significantly more hydrolysis-stable than Si—O—C bonds. However, the polysiloxane blocks containing Si—C bonds require costly and complex production by hydrosilylation using Pd or Pt catalysis. Such catalysts are costly. Typical polydimethylsiloxanes having Si—C bonds are shown in formulae (I) to (III):

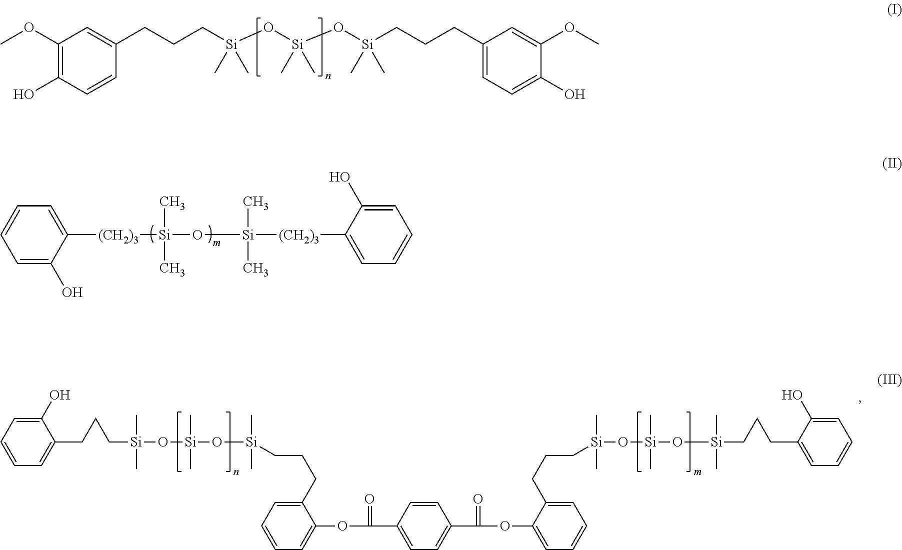

wherein n or m in formulae (I) to (III) in each case indicates the average number of repeating units.

By contrast, polysiloxanes having Si—O—C bonds are much easier to obtain without the use of costly Pd or Pt catalysts. For example, hydroquinone- or BPA-terminated siloxanes having an Si—O—C linkage are known (see for example WO 2013 155046A1).

However, it has been found that BPA- or hydroquinone-terminated polysiloxanes are not entirely homogeneously incorporated into the block co-condensate. According to the invention, the term “inhomogeneous incorporation” is preferably to be understood as meaning that the siloxane proportion of the acetone-soluble polymer fraction comprises only small polycarbonate or oligocarbonate proportions. This highly polysiloxane-rich phase may impair the polymer morphology due to the fact that large phases of polysiloxane-rich regions are formed. Without wishing to be bound to a particular theory, it can be assumed that the formation of such large siloxane domains is in some cases also due to the high tendency of polysiloxanes having Si—O—C bonds and/or Si—C bonds towards autocondensation. According to the invention, the term “autocondensation” is preferably understood as meaning the reaction of a polysiloxane block with a further polysiloxane block. However, in contrast to polysiloxanes having Si—C linkages, polysiloxanes having Si—O—C linkages also seem to exhibit a tendency for autocondensation, even if no carbonate donors such as phosgene or a diaryl carbonate such as diphenyl carbonate are involved in the reaction. The avoidance of autocondensation therefore appears to present a great challenge, especially in the case of polysiloxanes having Si—O—C bonds.

A high siloxane domain size has an adverse effect on the processing characteristics of the SiCoPC. Large domains can result in demixing which may manifest in an inhomogeneous surface structure and in some cases leads to flow lines and striping. Since large domains are shear sensitive such materials are also difficult to process by injection moulding and only very narrow processing windows are therefore possible. It is thus sometimes necessary to use very low injection speeds which is often undesirable since it reduces cycle times.

Prior art methods form large siloxane domains, especially when producing block co-condensates in the melt.

In the interfacial process, when using Si—C-bonded siloxane blocks, the siloxane domain size of an SiCoPC is typically below 100 nm. This makes it possible to obtain translucent or even transparent materials since the low domain size hardly results in any light scattering.

The production of siloxane-containing block co-condensates having a low haze from Si—C-bonded polydimethylsiloxane blocks is known in principle. WO 2004016674 A1 comprises producing a precondensate from an oligocarbonate and siloxane in the interfacial process which is then in a second step subjected to further condensation with a bisphenol in the interfacial process.

The melt transesterification process has the disadvantage that it is fundamentally impossible to operate the process in high dilution and the reactants are always highly concentrated. According to experience this results in the formation of siloxane domains between 0.1 and 10 μm in size.

SiCoPCs based on dihydroxydiphenylcycloalkanes of formula (1) are known in principle. Such structures are described in DE3926850 for example. However, these are block co-condensates synthesized from dihydroxydiphenylcycloalkanes, i.e. the polymers contain the special bisphenol in the polymer chain. However, this influences the properties of the resulting SiCoPC (especially the glass transition temperature). This is not always desirable for a wide variety of reasons.

EP 3 036 279 A1 likewise describes polysiloxanes which may be distinctly terminated. A termination with dihydroxydiphenylcycloalkanes is described, but these are not preferred. The application provides no information about the incorporation behaviour of such siloxane blocks in polycarbonate.

WO2016162301A1 describes a process for producing siloxane-containing block co-condensates containing dihydroxydiphenylcycloalkanes. The corresponding block co-condensates are produced in the melt transesterification process. However, here too, the dihydroxydiphenylcycloalkanes are present in the polycarbonate substructure and in the siloxane substructure.

### SUMMARY

Starting from the prior art, it was accordingly an object of the present invention to overcome at least one disadvantage, and preferably all disadvantages of the prior art. It was especially an object of the present invention to minimize the autocondensation of polysiloxanes containing at least one Si—O—C bond in the production of a SiCoPC. Instead, the reaction of the polysiloxane with the bisphenol or the oligocarbonate or the polycarbonate shall occur with preference. Polysiloxanes containing at least one Si—O—C bond should be used to avoid the costly and complex hydrosilylation using Pd or Pt catalysis. It was especially an object of the present invention to provide a polysiloxane-polycarbonate block co-condensate which comprises no significant polysiloxane-rich proportion (having only a low PC proportion) and features a particularly fine siloxane domain distribution. If the SiCoPC has a significant polysiloxane-rich proportion, the above-described effects occur. The polysiloxane-polycarbonate block co-condensate should further preferably be produced in the melt transesterification process. It was especially an object of the present invention to provide a polysiloxane-polycarbonate block co-condensate where at least 50% by volume, particularly preferably at least 75% by volume and very particularly preferably at least 90% by volume of all siloxane domains in the siloxane domain distribution of the polysiloxane-polycarbonate block co-condensate are in a range from greater than 0 to 50 nm.

At least one of the recited objects and preferably all of the recited objects have been achieved by the present invention.

It has surprisingly been found that polysiloxane blocks which comprise Si—O—C bonds and which are terminated with cycloaliphatically substituted/cycloaliphatics-containing bisphenols exhibit markedly more homogeneous incorporation into the SiCoPC. They further have a finer phase morphology. This indicates that the autocondensation of the polysiloxane was slowed down or inhibited/minimized by the special termination. The reactivity of the specially terminated polysiloxane towards compounds comprising the structure of formula (2) accordingly appears greater than their reactivity towards further specially terminated polysiloxanes. This was surprising since the cycloaliphatic bisphenols differ only insubstantially from the alkyl-containing bisphenols such as isopropylidenebisphenol (BPA). The improved siloxane domain size had the result that improved processing characteristics of the SiCoPC were obtained. The tendency for demixing was reduced and the processing window for injection moulding of the polycarbonate compositions according to the invention was widened.

Without wishing to be bound to a particular theory, the specially terminated polysiloxane block of the present invention might by virtue of its cycloaliphatic structure exhibit steric hindrance and/or electronic stabilization, which stabilizes the Si—O—C bond and minimizes the tendency for autocondensation.

According to the invention, the expression “more homogeneous incorporation into the SiCoPC” is preferably to be understood as meaning that proportionately more siloxane blocks are covalently bonded to polycarbonate blocks than if, for comparison, a BPA-terminated (bisphenol A-terminated) siloxane block is used under the same conditions. The BPA-terminated siloxane block preferably has the same structure as the polysiloxane employed according to the invention, with the exception that, according to the invention, the BPA structures have been replaced by the defined cycloaliphatic bisphenols.

Likewise, according to the invention the expression “finer siloxane domains or “finer phase morphology” is preferably to be understood as meaning that the siloxane domains and/or the phase morphology are smaller than if, by comparison, a BPA-terminated siloxane block is used under otherwise identical conditions.

The present invention accordingly provides a process for producing a polysiloxane-polycarbonate block co-condensate obtainable by reaction of at least one polysiloxane of formula (1)

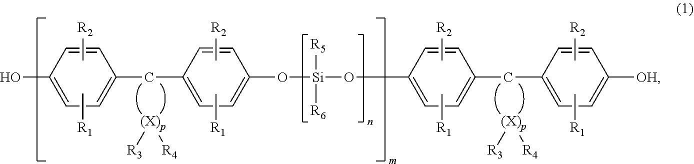

wherein each R₁ and R₂ independently represents hydrogen, halogen, C₁-C₅-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and
X represents carbon,
each R₅ and R₆ independently represents an aliphatic or an aromatic group, preferably represents methyl, ethyl, trimethylphenyl, —CH₂—CH₂-phenyl, —CH₂—CH₂—CH₂-phenyl, —CH₂—CH(CH₃)-phenyl, —CH₂—CH₂—CH₂-(2-methoxy)phenyl or phenyl,
n is an average number of repeating units from 10 to 400, preferably 10 to 100, particularly preferably 15 to 50 and
m is an average number of repeating units from 1 to 10, preferably 1 to 6, particularly preferably 1.5 to 5,
(i) with at least one compound of formula (2) and/or (2I) in the presence of at least one base and phosgene in the interfacial process,
(ii) with at least one compound of formula (2) and at least one diaryl carbonate in the melt transesterification process or
(iii) with at least one compound of formula (2II) and optionally at least one diaryl carbonate in the melt transesterification process,
wherein

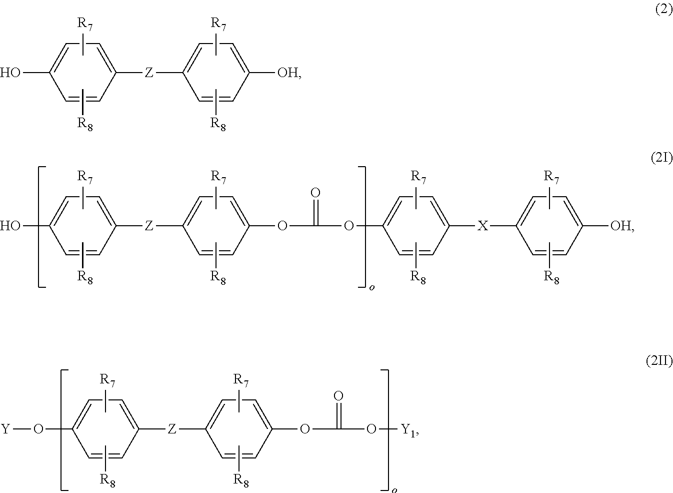

wherein each Z in formula (2), (2I) or (2II) independently represents a single bond, —S(═O)₂—, —C(═O)—, —O—, —S—, —S(═O)—,
—CH(CN)—, a linear or branched C₁-C₆-alkylene group, which may optionally comprise at least one carbonyl group, may optionally comprise at least one halogen atom and/or which may optionally be interrupted by at least one heteroatom, a C₂-C₁₀-alkylidene group, which may optionally comprise at least one carbon-carbon double bond, may optionally comprise at least one carbonyl group and/or may optionally comprise at least one halogen atom,
each R₇ and R₈ in formula (2), (2I) or (2II) independently represents hydrogen, halogen, C₁-C₈-alkyl, C₅-C₆-cycloalkyl, C₁-C₄-alkoxy, phenyl or C₇-C₁₂-aralkyl,
o in formula (2I) or (2II) represents the average number of repeating units and may be 2 to 40, preferably 7 to 31,
Y in formula (2II) represents hydrogen or —(C═O)—O-Ph, wherein Ph represents an optionally substituted phenyl and
Y₁ in formula (2II) represents optionally substituted phenyl or a compound of formula (2IIa), wherein

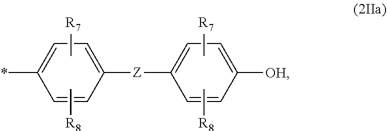

wherein each Z, R₇ and R₈ is as defined above for formula (2II) and “*” represents the site at which the structure of formula (2IIa) links to formula (2II) as Y₁.

It is preferable according to the invention to employ a polysiloxane of formula (1), wherein each R₁ and R₂ independently represents hydrogen or C₁-C₈-alkyl, particularly preferably hydrogen, R₃ and R₄ are individually selectable for each X and independently represent hydrogen or C₁-C₃-alkyl, particularly preferably represent hydrogen or methyl, p represents an integer from 4 to 7, preferably 4 to 6, particularly preferably 4 to 5, and X represents carbon, each R₅ and R₆ independently represent methyl, ethyl, trimethylphenyl, —CH₂—CH₂-phenyl, —CH₂—CH₂—CH₂-phenyl, —CH₂—CH(CH₃)-phenyl, —CH₂—CH₂—CH₂-(2-methoxy)phenyl or phenyl, preferably methyl or phenyl, n is an average number of repeating units from 10 to 400, preferably 10 to 100, particularly preferably 15 to 50, and m is an average number of repeating units from 1 to 10, preferably 1 to 6, particularly preferably 1.5 to 5.

It is apparent to those skilled in the art that formula (1) above may also be represented by formula (100)

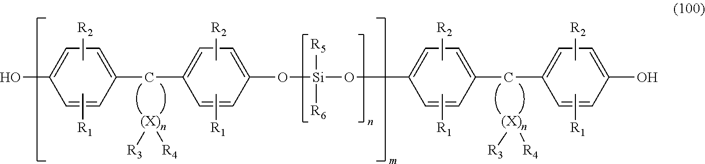

wherein each R₁ and R₂ independently represents hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, n is an integer from 4 to 7 and
X represents carbon,
each R₅ and R₆ independently represents an aliphatic or an aromatic group, preferably represents methyl, ethyl, trimethylphenyl, —CH₂—CH₂-phenyl, —CH₂—CH₂—CH₂-phenyl, —CH₂—CH(CH₃)-phenyl, —CH₂—CH₂—CH₂-(2-methoxy)phenyl or phenyl,
n is an average number of repeating units from 10 to 400 and
m is an average number of repeating units from 1 to 10.

According to the invention it is particularly preferable to employ a polysiloxane of formula (1), wherein each R₁ and R₂ represents hydrogen, R₃ and R₄ are individually selectable for each X and independently represent hydrogen or methyl, p is an integer 4 or 5 and X represents carbon, each R₅ and R₆ independently represents methyl or phenyl, n is an average number of repeating units from 10 to 400, preferably 10 to 100, particularly preferably 15 to 50, and m is an average number of repeating units from 1 to 10, preferably 1 to 6, particularly preferably 1.5 to 5.

It is very particularly preferable to employ a polysiloxane of formula (1A), wherein

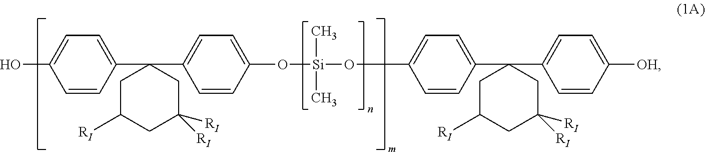

wherein each R₁ independently represents hydrogen or methyl, n is an average number of repeating units from 10 to 400, preferably 10 to 100, particularly preferably 15 to 50, and m is an average number of repeating units from 1 to 10, preferably 1 to 6, particularly preferably 1.5 to 5. It is particularly preferable when each R₁ in formula (1A) represents methyl.

In the context of the present invention, reference is often made to a “termination” of the polysiloxane of formula (1). A termination is preferably to be understood as meaning that all ends of the polysiloxane (generally 2) have a special organic group (see in this respect, for example, formula (1)).

The specially terminated polysiloxanes of formula (1) may be produced by various processes. The specially terminated polysiloxanes may be obtained, for example, by reacting bisacetoxyacyloxy-terminated siloxane blocks with the corresponding dihydroxydiphenylcycloalkanes. Production of acyloxy-terminated siloxanes is described, for example, in EP0003285 and in U.S. Pat. No. 4,584,360. The specially terminated polysiloxanes may also be produced via alpha,omega-dichloropolydimethylsiloxanes. This is described, for example, in U.S. Pat. No. 3,821,325. The dichlorosiloxane compound for example is reacted with the corresponding cycloaliphatic bisphenol in an inert solvent at temperatures between 0° C. and 100° C. in the presence of an acid acceptor.

The molecular weight (Mw) of the polysiloxane is preferably 2000 to 20 000 g/mol and especially preferably 2500-15 000 g/mol. The molecular weight is preferably determined as described below.

The polysiloxane of formula (1) is preferably present in a ratio of 0.5% to 50% by weight, preferably of 1% to 40% by weight, especially preferably of 2% to 20% by weight and very particularly preferably of 2.5% to 10% by weight, based on the sum of the weights of the polysiloxane of formula (1) and the compound comprising the structure of formula (2), (2I) and/or (2II) (depending on which of these compounds are used).

According to the invention, the polysiloxane of formula (1) is reacted
(i) with at least one compound of formula (2) and/or (2I) in the presence of at least one base and phosgene in the interfacial process,
(ii) with at least one compound of formula (2) and at least one diaryl carbonate in the melt transesterification process or
(iii) with at least one compound of formula (2II) and optionally at least one diaryl carbonate in the melt transesterification process.

It is preferable when each Z in formula (2), (2I) or (2II) is independently a single bond, —S(═O)₂—, —C(═O)—, —O—, —S—, —S(═O)—, —CH(CN)—, a linear or branched C₁-C₆-alkylene group or a C₂-C₁₀-alkylidene group and each R₇ and R₈ in formula (2), (2I) or (2II) independently represents hydrogen, C₁-C₈-alkyl or C₁-C₄-alkoxy. It is especially preferable when each Z in formula (2), (2I) or (2II) independently represents a single bond or a C₂-C₆-alkylidene group and
each R₇ and R₈ in formula (2), (2I) or (2II) independently represents hydrogen, C₁-C₃-alkyl or C₁-C₂-alkoxy.

It is very particularly preferable when each Z in formula (2), (2I) or (2II) independently represents a single bond or isopropylidene and
each R₇ and R₈ in formula (2), (2I) or (2II) independently represents hydrogen or methoxy, preferably hydrogen.

According to the invention, the polysiloxane of formula (1) is reacted with at least one compound of formula (2), (2I) or (2II). It is also conceivable for at least two compounds of formula (2), (2I) or (2II) to be reacted with the polysiloxane of formula (1). It is especially preferable when in the first compound of formula (2), (2I) or (2II), Z in each case represents isopropylidene and R₇ and R₈ each represent hydrogen. It is likewise preferable when in the second compound of formula (2), (2I) or (2II), Z in each case represents a single bond and R₇ and R₈ each represent hydrogen.

It is especially preferable when Z in formula (2), (2I) or (2II) represents isopropylidene. Accordingly, formula (2), (2I) or (2II) is derived from bisphenol A.

The reported numbers of o represent the average number of repeating units. The term “average number of repeating units” is known to those skilled in the art. Those skilled in the art know how this parameter may be determined. This parameter may especially be determined by GPC. It is preferably determined by the GPC method as described in the context of the present invention.

In the context of the present invention, the term “alkyl” or “alkyl group” preferably refers, unless otherwise stated, to an alkane structure from which a hydrogen atom has been removed. The alkyl group according to the present invention may be linear or branched. It is saturated and therefore comprises only single bonds between the adjacent carbon atoms. It is preferable when the alkyl group comprises methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, 1-ethyl-2-methylpropyl and the like. The selection of these structures may be limited if in the context of the present invention the number of carbon atoms is defined differently.

In the context of the present invention, the term “alkylene” or “alkylene group” preferably refers, unless otherwise stated, to a bridging alkane structure from which two hydrogen atoms have been removed from different carbon atoms. In this context, the two hydrogen atoms removed from the two carbon atoms can be removed from any carbon atoms in the alkane structure. This means that the two carbon atoms may be adjacent but need not necessarily be adjacent. An alkylene group may be linear or branched. It is saturated. If the alkylene group comprises only one carbon atom a methylene group (—CH₂—) is concerned which is connected to the remainder of the molecule via two single bonds It is preferable when the alkylene group comprises methylene, ethylene, n-propylene, iso-propylene, n-butylene, sec-butylene, tert-butylene, n-pentylene, 1-methylbutylene, 2-methylbutylene, 3-methylbutylene, neopentylene, 1-ethylpropylene, n-hexylene, 1,1-dimethylpropylene, 1,2-dimethylpropylene, 1,2-dimethylpropylene, 1-methylpentylene, 2-methylpentylene, 3-methylpentylene, 4-methylpentylene, 1,1-dimethylbutylene, 1,2-dimethylbutylene, 1,3-dimethylbutylene, 2,2-dimethylbutylene, 2,3-dimethylbutylene, 3,3-dimethylbutylene, 1-ethylbutylene, 2-ethylbutylene, 1,1,2-trimethylpropylene, 1,2,2-trimethylpropylene, 1-ethyl-1-methylpropylene, 1-ethyl-2-methylpropylene, 1-ethyl-2-methylpropylene and the like. The selection of these structures may be limited if in the context of the present invention the number of carbon atoms is defined differently. In addition, the alkylene group according to the present invention may optionally comprise at least one carbonyl group, may optionally comprise at least one halogen atom and/or may optionally be interrupted by at least one heteroatom. Examples of such alkylene groups include —C(═O)—(CH₂)₄—C(═O)—, —C(═O)—(CH₂)₃—C(═O)—, —C(═O)—(CH₂)₂—C(═O)—, —C(CF₃)₂, —O—(CH₂)₄—O—, —O—(CH₂)₃—O—, —O—(CH₂)₂—O— and the like.

In the context of the present invention, the term “alkylidene” or “alkylidene group” preferably refers, unless otherwise stated, to a bridging alkane structure from which two hydrogen atoms have been removed from the same carbon atom. The alkylidene group optionally comprises at least one carbon-carbon double bond, optionally at least one carbonyl group and/or optionally at least one halogen atom. It is preferable when the alkylidene group comprises isopropylidene, n-propylidene, isoheptylidene and the like.

In the context of the present invention, the term “aralkyl” preferably refers, unless otherwise stated, in each case independently to a linear, cyclic or branched alkyl group which is mono-, di- or polysubstituted with aryl radicals.

In the context of the present invention, the term “alkoxy” or “alkoxy group” preferably refers, unless otherwise stated, to a linear, cyclic or branched alkyl group which is bonded to an oxygen atom by a single bond (—OR). Alkoxy groups according to the present invention preferably have 1 to 6 carbon atoms. It is particularly preferable when alkoxy groups comprise methoxy, ethoxy, n-propoxy, isopropoxy, n-butoxy, sec-butoxy, tert-butoxy, n-pentoxy, 1-methylbutoxy, 2-methylbutoxy, 3-methylbutoxy, neo-pentoxy, 1-ethylpropoxy, cyclohexoxy, cyclopentoxy, n-hexoxy, 1,1-dimethylpropoxy, 1,2-dimethylpropoxy, 1,2-dimethylpropoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy, 1-ethyl-2-methylpropoxy or 1-ethyl-2-methylpropoxy. The selection of these structures may be limited if in the context of the present invention the number of carbon atoms is defined differently.

Based on the aforementioned definitions, those skilled in the art are able to understand further definitions which are not explicitly mentioned above.

The reaction of the polysiloxane according to (i) with at least one compound of formula (2) and/or (2I) is carried out according to the invention in the interfacial process. These processes and their specific process modes are known to those skilled in the art. The process is carried out in the interfacial process with phosgene and in the presence of a base. The use of at least one base in the interfacial process is also known to those skilled in the art. This is especially an aqueous alkali metal hydroxide or alkaline earth metal hydroxide solution. The at least one base is very particularly preferably an aqueous sodium hydroxide solution.

The interfacial process is described, for example, in H. Schnell, “Chemistry and Physics of Polycarbonates”, Polymer Reviews, Vol. 9, Interscience Publishers, New York 1964 page 33 et seq., and in Polymer Reviews, Vol. 10, “Condensation Polymers by Interfacial and Solution Methods”, Paul W. Morgan, Interscience Publishers, New York 1965, chapter VIII, page 325, and the employed reaction conditions are known to those skilled in the art. The interfacial process for producing polycarbonate is moreover also described, for example, in EP-A 0517044.

The interfacial process generally comprises phosgenation of a disodium salt of a diol/bisphenol or of a mixture of different diols/bisphenols, initially charged in aqueous alkaline solution or suspension, in the presence of an organic solvent or solvent mixture. The latter is generally inert and forms a second organic phase in addition to the aqueous phase. The resulting oligocarbonates primarily present in the organic phase are subjected to condensation with the aid of suitable catalysts to afford high molecular weight polycarbonates dissolved in the organic phase, wherein the molecular weight may be controlled by suitable chain terminators (for example monofunctional phenols). The organic phase is finally separated and the polycarbonate is isolated therefrom by various processing steps.

The condensation is commonly carried out in an inert solvent in the presence of alkali and a catalyst in the interface.

It is especially known to those skilled in the art that the OH end groups of the compounds of formulae (1), (2) and/or (2I) generally do not directly react with one another. The reaction is performed in the presence of a base. Salts may therefore be formed. The reaction can also be influenced in a manner known to those skilled in the art via different addition times of the reactants. In particular, the compound of formula (2) and/or (2I) may be phosgenated together with the polysiloxane of formula (1), a separate phosgenation of the components may be carried out or only one of the components may be reacted with phosgene. It is also possible to employ different dilutions. It is likewise apparent to those skilled in the art that the compound of formula (2) may be converted into the compound of formula (2I) according to the reaction mode. An advantageous process mode of the interfacial process having regard to the avoidance of autocondensation of polysiloxanes (having Si—C bonds) is described in US20040039145A.

The reaction of the polysiloxane of formula (1) according to (ii) or (iii) may alternatively be carried out in the melt transesterification process. This process and this mode of operation are also known to those skilled in the art. The reaction is carried out solventlessly by condensation in the melt starting from the compound of formula (2) with at least one diaryl carbonate or of formula (2II) and optionally at least one diaryl carbonate and the specially terminated polysiloxane. The process according to the invention is preferably performed according to (ii) or (iii). The process according to the invention is very particularly preferably performed according to (iii). It is apparent to those skilled in the art that there is a certain overlap between (ii) and (iii). In particular, the reaction according to (ii) can form a compound of formula (2II), so that (ii) can also pass over into (iii). A sharp delineation between (ii) and (iii) does not seem to be necessary according to the invention.

The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964) and in DE-C 10 31 512. In the melt transesterification process too it is known to those skilled in the art that the compounds of formula (2) and/or (2II) need not react directly but may optionally have other end groups as a result of further reactions. The process according to the invention is particularly preferably characterized in that the polysiloxane of formula (1) is reacted (iii) with at least one compound of formula (2II) in the melt transesterification process.

The diaryl carbonate is preferably a compound of formula (III)

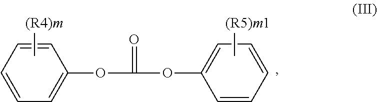

wherein
R4 and R5 independently represent H, C₁-C₃₄-alkyl, C₇-C₃₄-aralkyl, C₆-C₃₄-aryl or —COO—R′, wherein R′ corresponds to a C₁-C₃₄-alkyl, C₇-C₃₄-aralkyl, C₆-C₃₄-aryl, and
m and m1 are independently an integer from 1 to 5 and, if m is a number from 2 to 5, each radical R4 may be identical or different and, if m1 is a number from 2 to 5, each radical R5 may be identical or different.

It is particularly preferable when the diaryl carbonate is diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate and di[4-(1-methyl-1-phenylethyl)phenyl]carbonate, very particularly preferably diphenyl carbonate.

If the process according to the invention is performed in the melt transesterification process, it is further preferable when the process according to the invention is performed in an extruder, in high-viscosity reactors or thin-film evaporators.

The extruder or melt reactor may be a single-screw reactor, a twin-screw reactor or a multi-screw reactor, for example, a planetary roller extruder or a ring extruder. A high-volume kneader reactor may also be concerned. The process may be carried out in a single apparatus—for example a twin-screw extruder or else in two stages, i.e. a reactor combination. The reactor combination preferably consists of a pre-reactor—such as a twin-screw extruder—and a high-viscosity reactor. Advantageous process modes are described in particular in EP21187927 and EP21187920.

It is moreover preferable when the compound comprising the structure of formula (2I) has a relative solution viscosity eta rel of 1.08 to 1.22, preferably 1.11 to 1.22 and particularly preferably 1.13 to 1.20. The relative solution viscosity (frel; also referred to as eta rel) is preferably determined in dichloromethane at a concentration of 5 g/l at 25° C. using an Ubbelohde viscometer. Those skilled in the art are familiar with the determination of relative solution viscosity using an Ubbelohde viscometer. According to the invention, this is preferably performed according to DIN 51562-3; 1985-05. In this determination, the transit times of the compound under investigation are measured by the Ubbelohde viscometer in order to then determine the difference in viscosity between the polymer solution and its solvent. For this purpose, the Ubbelohde viscometer is first calibrated by analysing the pure solvents dichloromethane, trichloroethylene and tetrachloroethylene (always performing at least 3 and at most 9 measurements). The actual calibration is then carried out using the solvent dichloromethane. The sample is then weighed out and dissolved in dichloromethane and then the flow time is determined three times for this solution. The average value for the flow times is corrected via the Hagenbach correction and the relative solution viscosity is calculated.

The compound comprising the structure of formula (2I) is preferably a polycarbonate. In the context of the present invention the term polycarbonates comprises both homopolycarbonates and copolycarbonates and also mixtures of polycarbonates. The polycarbonates may be linear or branched in known fashion.

Production of the polycarbonates may be carried out in known fashion by the melt transesterification process or the interfacial process.

Such polycarbonates preferably have molecular weights (Mw) of 8000 to 19 000 g/mol, particularly preferably of 10 000 to 18 000 g/mol and especially preferably of 12 000 to 18 000 g/mol. These polycarbonates preferably further have a content of phenolic OH groups of 250 ppm to 2500 ppm, preferably 500 to 2000 ppm and especially preferably of 1000 to 1800 ppm. The phenolic OH groups are preferably determined by IR spectroscopy.

The method used for determining the molar masses reported in the context of the invention for the polycarbonate, the polysiloxane or the polysiloxane-polycarbonate block co-condensate is method no. 2301-0257502-09D of Currenta GmbH & Co. OHG (2009 version) which is available upon request from Currenta. Calibration is carried out with linear polycarbonates (composed of bisphenol A and phosgene) of known molar mass distribution from PSS Polymer Standards Service GmbH, Germany. The eluent is dichloromethane. Column combination of crosslinked styrene-divinylbenzene resins. Diameter of analytical columns: 7.5 mm; length: 300 mm. Particle sizes of the column material: 3 μm to 20 μm. Concentration of solutions: 0.2% by weight. Flow rate: 1.0 m1/min, temperature of solutions: 30° C. Detection using a refractive index (RI) detector, UV detector or IR detector, preferably a refractive index detector. Detection is particularly preferably effected using an RI detector or a UV detector in each case with an IR detector. The RI detector and the UV detector are especially sensitive to polycarbonate-containing polymer chains (especially BPA polycarbonate-containing polymer chains). In order to also allow detection of the polysiloxane-containing polymer chains (especially the polydimethylsiloxane-containing polymer chains), the IR detector is preferably adjusted to the Si—O vibration band. This is at about 1050 cm⁻¹. Preference is given to the simultaneous use of a UV, RI and IR detector.

When the melt transesterification process is used for producing the SiCoPC, a preferred embodiment comprises employing polycarbonates containing particular rearrangement structures. The polycarbonates for use in this embodiment contain at least one, preferably more than one, of the following structures (4) to (7):

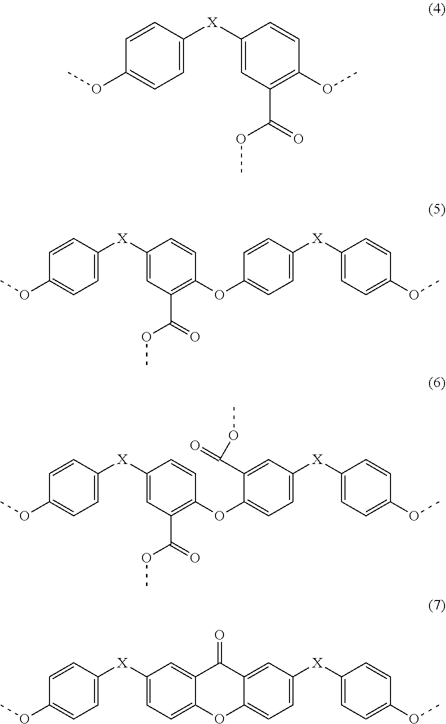

in which the phenyl rings may independently of one another be mono- or disubstituted with C1-C8 alkyl, halogen, preferably C1 to C4 alkyl, particularly preferably with methyl and X represents a single bond, C1 to C6 alkylene, C2 to C5 alkylidene or C5 to C6 cycloalkylidene, preferably a single bond or C1 to C4 alkylene and especially preferably isopropylidene, wherein the amount of structural units (4) to (7) in total (determined after hydrolysis) is generally in the range from 50 to 1000 ppm, preferably in the range from 80 to 850 ppm.

In order to determine the amount of the rearrangement structures, the respective polycarbonate is subjected to a total hydrolysis to form the corresponding decomposition products of formulae (4a) to (7a), the amount of which is determined by HPLC. The structures (4a) to (7a) are reported by way of example for the use of a polycarbonate comprising bisphenol A. (This can be accomplished for example as follows: The polycarbonate sample is hydrolysed under reflux by means of sodium methoxide. The corresponding solution is acidified and concentrated to dryness. The drying residue is dissolved in acetonitrile and the phenolic compounds of formula (1a) to (4a) are determined by means of HPLC with UV detection):

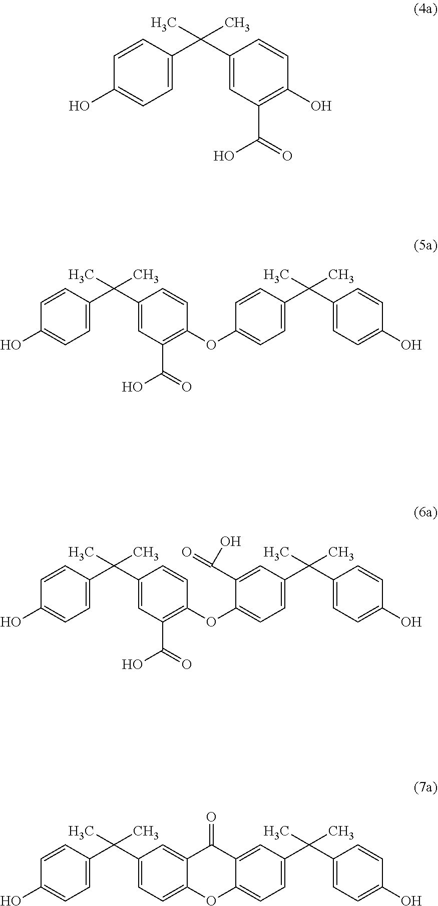 [SMILES: CC(C)(c1ccc(O)cc1)c1ccc(O)c(C(=O)O)c1 ; CC(C)(c1ccc(O)cc1)c1ccc(Oc2ccc(C(C)(C)c3ccc(O)cc3)cc2C(=O)O)cc1 ; CC(C)(c1ccc(O)cc1)c1ccc(Oc2ccc(C(C)(C)c3ccc(O)cc3)cc2C(=O)O)c(C(=O)O)c1 ; CC(C)(c1ccc(O)cc1)c1ccc2oc3ccc(C(C)(C)c4ccc(O)cc4)cc3c(=O)c2c1]

The amount of the thus-liberated compound of formula (4a) is preferably 20 to 800 ppm, particularly preferably 25 to 700 ppm and especially preferably 30 to 500 ppm.

The amount of the thus-liberated compound of formula (5a) is preferably 0 (i.e. below the detection limit of 10 ppm) to 100 ppm, particularly preferably 0 to 80 ppm and especially preferably 0 to 50 ppm.

The amount of the thus-liberated compound of formula (6a) is preferably 0 (i.e. below the detection limit of 10 ppm) to 800 ppm, more preferably 10 to 700 ppm, particularly preferably 20 to 600 ppm and very particularly preferably 30 to 350 ppm.

The amount of the thus-liberated compound of formula (7a) is preferably 0 (i.e. below the detection limit of 10 ppm) to 300 ppm, preferably 5 to 250 ppm and especially preferably 10 to 200 ppm.

The production of such polycarbonates containing the abovementioned rearrangement structures is described, for example, in DE 102008019503.

The process is preferably performed in the melt transesterification process at temperatures of 280° C. to 400° C., preferably of 290° C. to 380° C., more preferably of 300° C. to 350° C., and pressures of 0.001 mbar to 50 mbar, preferably 0.005 mbar to 40 mbar, especially preferably 0.02 to 30 mbar and very particularly preferably 0.03 to 5 mbar, preferably in the presence of a catalyst.

It is preferable when the reaction according to (i) to (iii) in the process according to the invention is performed in the presence of a catalyst. A reaction mode without a catalyst is possible in principle but higher temperatures or longer residence times may have to be accepted as a result. Catalysts for the interfacial process according to (i) are known to those skilled in the art.

If the process according to the invention is performed by the melt transesterification process (see (ii) and (iii)), suitable catalysts include for example:
ammonium catalysts such as for example tetramethylammonium hydroxide, tetramethylammonium acetate, tetramethylammonium fluoride, tetramethylammonium tetraphenylboranate, dimethyldiphenylammonium hydroxide, tetraethylammonium hydroxide, cetyltrimethylammonium tetraphenylboranate and cetyltrimethylammonium phenoxide. Especially suitable catalysts also include phosphonium catalysts of formula (K):

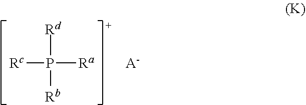

wherein R^{a}, R^{b}, R^{c} and R^{d} may be identical or different C1-C10-alkyls, C6-C14-aryls, C7-C15-arylalkyls or C5-C6-cycloalkyls, preferably methyl or C6-C14-aryls, particularly preferably methyl or phenyl, and A may be an anion such as hydroxide, sulfate, hydrogensulfate, hydrogencarbonate, carbonate or a halide, preferably chloride or an alkoxide or aroxide of formula —OR, wherein R may be a C6-C14-aryl, C7-C15-arylalkyl or C5-C6-cycloalkyl, preferably phenyl.

Particularly preferred catalysts are tetraphenylphosphonium chloride, tetraphenylphosphonium hydroxide or tetraphenylphosphonium phenoxide; tetraphenylphosphonium phenoxide is very particularly preferred. It is particularly preferable to employ the alkali metal salts or alkaline earth metal salts of these ammonium and/or phosphonium catalysts.

The catalyst is preferably employed in amounts of 0.0001% to 1.0% by weight, preferably of 0.001% to 0.5% by weight, especially preferably of 0.005% to 0.3% by weight and very particularly preferably of 0.01% to 0.15% by weight based on the weight of formula (2) or (2II) (depending which is used).

The catalyst may be employed alone or as a catalyst mixture and may be added in pure form or as a solution, for example in water or in phenol, for example as a solid solution with phenol. It may be introduced into the reaction for example by means of a masterbatch, preferably with that of the compound of formula (2II), or added separately/in addition.

It is likewise preferable when the compound of formula (2II) and the polysiloxane of formula (1) are reacted in the presence of an organic or inorganic salt of a weak acid having a pK_{A} in the range from 3 to 7 (25° C.). This salt may also be referred to as co-catalyst. Suitable weak acids comprise carboxylic acids, preferably C2-C22-carboxylic acids such as for example acetic acid, propanoic acid, oleic acid, stearic acid, lauric acid, benzoic acid, 4-methoxybenzoic acid, 3-methylbenzoic acid, 4-tert-butylbenzoic acid, p-tolueneacetic acid, 4-hydroxybenzoic acid and salicylic acid, partial esters of polycarboxylic acids, for example monoesters of succinic acid, partial esters of phosphoric acids, for example mono- or diorganic phosphoric esters, branched aliphatic carboxylic acids, such as for example 2,2-dimethylpropionic acid, 2,2-dimethylbutanoic acid, 2,2-dimethylpentanoic acid and 2-ethylhexanoic acid.

Suitable organic or inorganic salts are selected from or derived from hydrogencarbonate, potassium hydrogencarbonate, lithium hydrogencarbonate, sodium carbonate, potassium carbonate, lithium carbonate, sodium acetate, potassium acetate, lithium acetate, sodium stearate, potassium stearate, lithium stearate, sodium oleate, potassium oleate, lithium oleate, sodium benzoate, potassium benzoate, lithium benzoate, disodium, dipotassium or dilithium salts of bisphenol A. The salts may further comprise calcium hydrogencarbonate, barium hydrogencarbonate, magnesium hydrogencarbonate, strontium hydrogencarbonate, calcium carbonate, barium carbonate, magnesium carbonate, strontium carbonate, calcium acetate, barium acetate, magnesium acetate, strontium acetate, calcium stearate, barium stearate, magnesium stearate, strontium stearate and the corresponding oleates. All these salts may be used alone or in any desired mixtures.

The salt is particularly preferably selected from the group consisting of alkali metal salts, alkaline earth metal salts and phosphonium salts of carboxylic acids. In a further preferred embodiment the organic or inorganic salt is derived from a carboxylic acid.

The organic or inorganic salts are preferably employed in amounts of 0.08 to 10 ppm and very particularly preferably of 0.1 to 5 ppm based on the total weight of the polysiloxane and the organic or inorganic salt.

In a preferred embodiment the organic or inorganic salt is a sodium salt, preferably a sodium salt of a carboxylic acid. It is preferably employed in an amount such that the sodium content in the resulting polysiloxane-polycarbonate block co-condensate is in the range from 0.003 ppm to 0.5 ppm based on the total weight of the polysiloxane-polycarbonate block co-condensate that is to be formed. The co-catalyst is preferably dissolved in the polysiloxane of formula (1) with a suitable solvent. The sodium content of the polysiloxane-polycarbonate block co-condensate may be determined by atomic absorption spectroscopy for example.

The organic or inorganic salt may be employed alone or in any desired mixtures. It may be added as a solid or in solution. In a preferred embodiment, the organic or inorganic salt is added in the form of a mixture containing the polysiloxane of formula (1) and the organic or inorganic salt.

The catalysts may be employed alone or in admixture and be added in pure form or as a solution, for example in water or in phenol.

It is especially preferable when the at least one catalyst is incorporated into the compound of formula (2II) and the co-catalyst is incorporated into the polysiloxane of formula (1).

The catalyst is preferably employed in amounts of 0.0001% to 1.0% by weight, preferably of 0.001% to 0.5% by weight, especially preferably of 0.005% to 0.3% by weight and very particularly preferably of 0.01% to 0.15% by weight based on the sum of the polysiloxane and the compound of (2) or (2II) (depending which is employed).

The process according to the invention is preferably characterized in that at least 50% by volume, particularly preferably at least 60% by volume, likewise preferably at least 70% by volume, likewise preferably at least 75% by volume, likewise preferably at least 80% by volume, very particularly preferably at least 90% by volume of all siloxane domains of the siloxane domain distribution of the polysiloxane-polycarbonate block co-condensate are in a range from greater than 0 to 50 nm, wherein the siloxane domain distribution is measured by atomic force microscopy. The siloxane domain distribution is the diameter of the siloxane domains. It is apparent to those skilled in the art that siloxane domains equal to 0 nm cannot be present. There are nevertheless evaluation programs that calculate a siloxane domain distribution from 0 (and not greater than 0 nm) to 50 nm. According to the invention, it is preferable when this range from 0 to 50 nm is also covered by the defined range “greater than 0 to 50 nm”. The evaluation programs likewise exhibit ranges from 50 to 100 nm and 100 to 200 nm. An overlapping of the ranges at 50 nm and 100 nm is apparent in each case. However, it is apparent to those skilled in the art (in the same way as for “0 nm”) that the lower limit is preferably to be understood as meaning greater 50 nm or greater than 100 nm. This means that the three ranges are preferably to be understood as meaning “>0 nm to 50 nm”, “>50 nm to 100 nm” and “>100 nm to 200 nm”. It has been found according to the invention that a very fine siloxane domain distribution was obtained. The use of the special polysiloxane minimized autocondensation of the polysiloxane and thus likewise minimized the size of the siloxane domains.

To determine the size of the polysiloxane domains polymer samples are cut at low temperature and subjected to examination by scanning electron microscopy as more particularly described below. This is preferably done using the parameters described in the examples section and the process described therein. In the context of the present invention the diameter of a polysiloxane domain is to be understood here as meaning the diameter of the equivalent projection area of a circle of the cross section of the polysiloxane domain visible in the cut.

A further aspect of the present invention provides a polysiloxane-polycarbonate block co-condensate comprising at least one Si—O—C bond, characterized in that at least 50% by volume, particularly preferably at least 60% by volume, likewise preferably at least 70% by volume, likewise preferably at least 75% by volume, likewise preferably at least 80% by volume, very particularly preferably at least 90% by volume, of all siloxane domains of the siloxane domain distribution of the polysiloxane-polycarbonate block co-condensate are in a range from greater than 0 to 50 nm, wherein the siloxane domain distribution is measured by atomic force microscopy. It has surprisingly been found that minimizing the autocondensation tendency of the polysiloxane itself with polysiloxanes comprising at least one Si—O—C bond made it possible to obtain very fine siloxane domain distributions. This provides SiCoPCs obtainable from polysiloxanes which do not require costly and complex hydrosilylation using Pd or Pt catalysts but at the same time exhibit very fine siloxane domain distributions.

In one aspect, the polysiloxane-polycarbonate block co-condensate according to the present invention is obtained in all configurations and combinations of preferences by the process according to the invention.

The polysiloxane-polycarbonate block co-condensate according to the present invention is preferably characterized in that the polysiloxane-polycarbonate block co-condensate comprises structures of formula (1a)

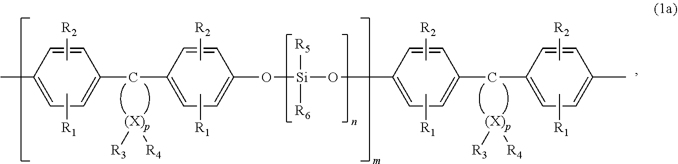

wherein each R₁ and R₂ independently represents hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and
X represents carbon,
each R₅ and R₆ independently represents an aliphatic or an aromatic group, preferably represents methyl, ethyl, trimethylphenyl, —CH₂—CH₂-phenyl, —CH₂—CH₂—CH₂-phenyl, —CH₂—CH(CH₃)-phenyl, —CH₂—CH₂—CH₂—(2-methoxy)phenyl or phenyl,
n is an average number of repeating units from 10 to 400, preferably 10 to 100, particularly preferably 15 to 50,
m is an average number of repeating units from 1 to 10, preferably 1 to 6, particularly preferably 1.5 to 5 and
“ . . . ” represents the sites at which the structure of formula (1a) is incorporated into the polysiloxane-polycarbonate block co-condensate.

All preferences in relation to formula (1) are also applicable to formula (1a) in any desired combinations. Those skilled in the art are capable of establishing the relationship between the polysiloxane of formula (1) and the SiCoPC comprising structures of formula (1a). This is especially because the structures of formula (1a) are derived from formula (1).

It is further preferable when the polysiloxane-polycarbonate block co-condensate according to the present invention comprises structures of formula (2a)

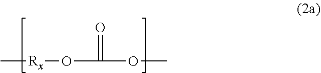

wherein each R_{X} is independently a divalent substituted or unsubstituted aromatic radical.

It is preferable when formula (2a) is represented by formula (2A), wherein

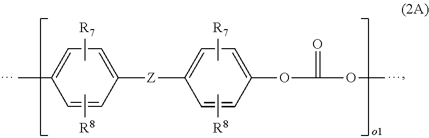

wherein each Z in formula (2A) is independently a single bond, —S(═O)₂—, —C(═O)—, —O—, —S—, —S(═O)—, —CH(CN)— or a linear or branched C₁-C₆-alkylene group which may optionally comprise at least one carbonyl group, may optionally comprise at least one halogen atom and/or which may optionally be interrupted by at least one heteroatom or a C₂-C₁₀-alkylidene group which may optionally comprise at least one carbon-carbon double bond, may optionally have at least one carbonyl group and/or may optionally have at least one halogen atom,
each R₇ and R₈ independently represents hydrogen, halogen, C₁-C₈-alkyl, C₅-C₆-cycloalkyl, C₁-C₄-alkoxy, phenyl or C₇-C₁₂-aralkyl,
o1 is the average number of repeating units and may preferably be 2 to 31, more preferably 7 to 31, and
“ . . . ” represents the sites at which the structure of formula (2A) is incorporated into the polysiloxane-polycarbonate block co-condensate.

The preferences for Z, R₇ and R₈ described for formula (2), (2I) and (2II) in each case also apply to formula (2A).

The polysiloxane-polycarbonate block co-condensate according to the invention is particularly preferably characterized in that the structure of formula (2a) is represented by the structure of formula (2b)

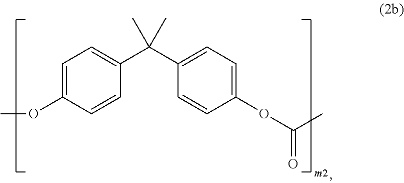

wherein m2 indicates the average number of repeating units. In this case the polycarbonate block of the SiCoPC is derived from bisphenol A. It is preferable when o in formula (2b) is 7 to 31, particularly preferably 10 to 29, likewise particularly preferably 15 to 28, very particularly preferably 19 to 27.

It has been found according to the invention that the proportion of covalent bonds between the siloxane blocks and the polycarbonate blocks is high. The proportion of covalent bonds between the siloxane blocks and the polycarbonate blocks is preferably higher than if a BPA-terminated polysiloxane of the same chemical structure is employed under the same conditions.

The polysiloxane content of the SiCoPC according to the invention is preferably 2% to 15% by weight, particularly preferably 3% to 11% by weight and very particularly preferably 4% to 10% by weight, wherein the polysiloxane content is based on the total weight of polysiloxane-polycarbonate block copolymer.

The polysiloxane-polycarbonate block co-condensate according to the present invention is likewise preferably characterized in that the polysiloxane-polycarbonate block co-condensate has a weight-average molecular weight of 24 000 to 40 000 g/mol, preferably of 25 000 to 36 000 g/mol and especially preferably of 26 000 to 34 000 g/mol. It is particularly preferable when this molecular weight is measured by GPC using a polycarbonate standard and detected by RI detection. It is preferable to employ the aforementioned GPC method.

The SiCoPC according to the invention or the SiCoPC obtained by the process according to the invention may be processed as such to afford shaped articles of any kind. It may also be processed with other thermoplastics and/or polymer additives to afford thermoplastic moulding compounds. The moulding compounds and shaped articles are further subjects of the present invention.

The polymer additives are preferably selected from the group consisting of flame retardants, anti-drip agents, flame retardant synergists, smoke inhibitors, lubricants and demoulding agents, nucleating agents, antistats, conductivity additives, stabilizers (e.g. hydrolysis, heat aging and UV stabilizers and transesterification inhibitors), flow promoters, phase compatibilizers, dyes and pigments, impact modifiers and fillers and reinforcers.

The moulding compounds according to the invention are thermoplastic. They may be produced for example by mixing the SiCoPC and the further constituents and melt-compounding and melt-extruding the resulting mixture at temperatures of preferably 200° C. to 320° C. in customary apparatuses, for example internal kneaders, extruders, and twin-shaft screw systems, in a known manner. In the context of the present application, this process is generally referred to as compounding.

The term “moulding compound” is thus to be understood as meaning the product obtained when the constituents of such a composition are melt-compounded and melt-extruded.

The shaped articles composed of the SiCoPC according to the invention, of the SiCoPC obtained by the process according to the invention or the thermoplastic moulding compounds containing the SiCoPC may be produced for example by injection moulding, extrusion and blow-moulding processes. A further form of processing is the production of shaped articles by thermoforming from previously produced sheets or films.

The polysiloxane-polycarbonate block co-condensates obtainable by the process according to the invention and the polycarbonate compositions according to the invention are employable anywhere where known aromatic polycarbonates have hitherto been used and where good flowability coupled with improved mould release characteristics, high toughness at low temperatures and better chemicals resistance are additionally required, for example for production of large motor vehicle exterior parts and control boxes for exterior applications, of sheets, twin-wall sheets, of parts for electricals and electronics and of optical storage media. The block co-condensates may thus be employed in the IT sector for computer housings, multimedia housings and mobile phone housings, in the household sector such as in washing machines or dishwashers and in the sports sector, for example as a material for helmets.

A further aspect of the present invention provides for a use of a bisphenol of formula (3)

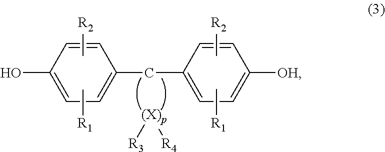

wherein R₁ and R₂ each independently represent hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and
X represents carbon
for terminating a polysiloxane, wherein after reaction with the bisphenol of formula (3) the polysiloxane has at least one Si—O—C bond, to increase the reactivity of a terminated polysiloxane having an Si—O—C bond in the reaction with a bisphenol, oligocarbonate and/or polycarbonate.

It is apparent to those skilled in the art that all preferences described above in relation to R₁-R₄, X and p in formula (1) are likewise applicable to formula (3). It is very particularly preferable when formula (3) is formula (3a)

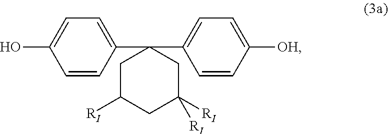

wherein each R₁ independently represents hydrogen or methyl. It is particularly preferable when each R₁ in formula (3a) represents methyl. Bisphenol TMC is concerned in this case.

It is likewise apparent to those skilled in the art that formula (3) may also be represented by formula (300),

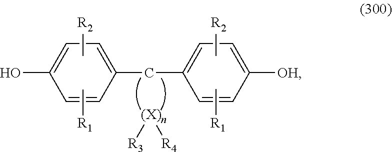

wherein R₁ and R₂ each independently represent hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, n is an integer from 4 to 7 and
X represents carbon.

According to the invention it has been found that, relative to BPA, a bisphenol of formula (3) increases the reactivity of a correspondingly terminated polysiloxane to such an extent that autocondensation of the resulting polysiloxane can be minimized. This makes it possible to obtain a SiCoPC having a fine siloxane domain distribution and an elevated proportion of covalent bonds between the siloxane blocks and the polycarbonate blocks.

A further aspect of the present invention is accordingly the use of a polysiloxane of formula (1)

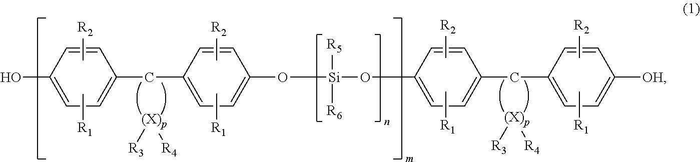

wherein each R₁ and R₂ independently represents hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and X represents carbon,
each R₅ and R₆ independently represents an aliphatic or an aromatic group, preferably represents methyl, ethyl, trimethylphenyl, —CH₂—CH₂-phenyl, —CH₂—CH₂—CH₂-phenyl, —CH₂—CH(CH₃)-phenyl, —CH₂—CH₂—CH₂—(2-methoxy)phenyl or phenyl,
n is an average number of repeating units from 10 to 400, preferably 10 to 100, particularly preferably 15 to 50 and
m is an average number of repeating units from 1 to 10, preferably 1 to 6, particularly preferably 1.5 to 5,
in the production of a polysiloxane-polycarbonate block co-condensate to increase the proportion of covalent bonds between the siloxane blocks and the polycarbonate blocks, wherein the polysiloxane has at least one Si—O—C bond.

The formula (1) has already been described above in further preferences which are also applicable in the use according to the invention. The SiCoPC according to the invention has likewise already been more particularly described above. It has surprisingly been found that a specially terminated polysiloxane block increases the proportion of covalent compounds between the siloxane blocks and the polycarbonate blocks. An increased proportion of covalent bonds between these blocks makes it possible to achieve a finer siloxane domain distribution.

### BRIEF DESCRIPTION OF THE DRAWINGS

FIG. 1: GPC curve of example 3 using triple detection. The black curve represents the curve with UV detection. The light-grey curve represents the curve with IR detection. The mid-grey curve is the curve with refractive index (RI) detection.

FIG. 2: GPC curve of example 4 using triple detection. The black curve represents the curve with UV detection. The light-grey curve represents the curve with IR detection. The mid-grey curve is the curve with refractive index (RI) detection.

### DETAILED DESCRIPTION

There follows a detailed description of the invention with reference to working examples, and the methods of determination described here are employed for all corresponding parameters in the present invention, in the absence of any statement to the contrary.

### MVR

Unless stated otherwise, the melt volume flow rate (MVR) is determined according to ISO 1133 (2011) (at 300° C.; 1.2 kg), unless any other conditions are stated.

### Solution Viscosity

Determination of solution viscosity: Relative solution viscosity (ηrel; also referred to as eta rel) was determined in dichloromethane at a concentration of 5 g/l at 25° C. using an Ubbelohde viscometer.

### Materials:

### Bisphenol A:

Dichlorosiloxane: Poly(dimethylsiloxane), chlorine-terminated, viscosity 20-50 cSt.; molecular weight about 2000-4000 g/mol; CAS 67923-13-7; abcr GmbH; 76187 Karlsruhe, Germany

Pyridine: Anhydrous, 99%, CAS 110-86-1; Sigma-Aldrich, Munich, Germany

TMC bisphenol: 4,4′-(3,3,5-Trimethylcyclohexylidene)bisphenol, manufactured by Covestro Deutschland AG

PC-1: Linear bisphenol A polycarbonate having end groups based on phenol and having a solution viscosity of 1.17. This polycarbonate contains no additives such as UV stabilizers, mould release agents or thermal stabilizers. The polycarbonate was produced by a melt transesterification process as described in DE 102008019503. The polycarbonate has a content of phenolic end groups of 0.16%.

### Evaluation of the Siloxane Domain Size Using Atomic Force Microscopy (AFM)

The siloxane domain size and distribution were determined using atomic force microscopy. To this end, the corresponding sample (in the form of a melt cake) was cut at low temperature (nitrogen cooling) using an ultramicrotome. A Bruker D3100 AFM microscope was used. The AFM image was recorded at room temperature (25° C., 30% relative humidity). “Soft Intermittent Contact Mode” or “Tapping Mode” was used for the measurement. A “tapping mode cantilever” (Nanoworld pointprobe) having a spring constant of about 2.8 Nm⁻¹ and a resonance frequency of about 75 kHz was used to scan the sample. The tapping force is controlled by the ratio of the target amplitude and the free oscillation amplitude (amplitude of the probe tip with free oscillation in air). The sampling rate was set to 1 Hz. To record the surface morphology phase contrast and topography images were recorded on a 2.5 μm×2.5 μm area. The particles/siloxane domains were evaluated automatically using Olympus SIS image processing software (Olympus Soft Imaging Solutions GmbH, 48149, Munster, Germany) via light-dark contrast (from the phase contrast images). The diameters of the particles were determined from the diameter of the corresponding equal area circle of the longest dimension of the particle.

A plurality of phase contrast images (number of particles greater than 200) are evaluated as described above. The image processing software is used to classify the individual diameters and capture a distribution of the diameters. This is used for assignment to individual D values/the corresponding volume fractions. The D value indicates the proportion of particles smaller than the specified value. At a D90 value of x, 90% of the particles are smaller than x. The proportion of particles having a diameter of 0-50 nm, 50-100 nm and 100-200 nm is also determined from the distribution.

### GPC:

Molecular weights were determined by means of gel permeation chromatography with dichloromethane as eluent. The standard used was BPA polycarbonate. The signal from the refractive index detector was used. The corresponding method is defined under No. 2301-0257502-09D at Currenta GmbH & Co. OHG, which can be requested at any time from Currenta. In addition, to interpret the GPC results the polymer sample was detected using a plurality of detectors in order to be able to evaluate the distribution of both the UV-active components (bisphenols) and the non-UV-active components. The UV detector was set to 254 nm and was thus sensitive to BPA polycarbonate; the further detectors employed were an RI (refractive index) detector and an IR detector. The IR detector was set to 1050 cm⁻¹ and was thus sensitive to the Si—O—Si stretching vibration. It was thus possible to recognize both the polycarbonate-containing polymer components and siloxane-containing polymer components in parallel. This type of detection is also referred to as “triple detection” below.

### Example 1 (Comparative Example) Production of a BPA-Terminated Siloxane Block

A 250 m1 glass flask fitted with a stirrer and dropping funnel was baked out, evacuated and filled with dry argon. 12.18 g (0.053 mol) of bisphenol A and 8.38 g (0.106 mol) of pyridine were initially charged in 100 m1 of anhydrous dichloromethane under an argon atmosphere and dissolved with stirring. 20 g (viscosity 20-50 cSt) of dichlorosiloxane were initially charged in the dropping funnel and added dropwise at room temperature with vigorous stirring to the bisphenol A solution over the course of 50 minutes. Once the entirety of the siloxane derivative had been added, the mixture was stirred for a further 1 hour.

The solution was neutralized by dropwise addition of 1 M hydrochloric acid and adjusted to slightly acidic pH (pH<4); the solution was then transferred to a separating funnel and washed with demineralized water at least three times. If the solution was still distinctly acidic, the mixture was washed until the pH indicated an approximately neutral solution. The solvent was removed on a rotary evaporator to leave behind a suspension. The crude product was taken up in n-hexane, leaving behind the excess BPA as a solid, and then dried over a molecular sieve (4 A) and filtered. The solution was concentrated as far as possible at <1 mbar and 50° C. for at least 0.5 h and filtered through a 5 m Teflon filter. This afforded a colourless oil.

NMR: ¹H NMR (Bruker AV III HD 600 MHz NMR spectrometer; CDCl₃): 7.06-7.10 ppm (m, 4H), 6.78-6.81 (m, 2.18 H), 6.70-6.73 (m, 1.81 H), 1.60 ppm (s, 6.32 H), 0-0.2 ppm (m, 108.39 H).

This corresponds to an aryl-terminated siloxane of formula

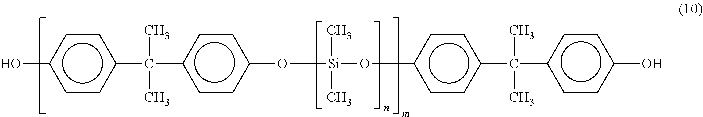

having an n of about n=30 and an m of about m=1.2.

### Example 2 (Inventive Example) Production of a TMC BP-Terminated Siloxane Block

A 250 m1 glass flask fitted with a stirrer and dropping funnel was baked out, evacuated and filled with dry argon. 16.56 g (0.053 mol) of TMC bisphenol and 8.38 g (0.106 mol) of pyridine were initially charged in 100 m1 of anhydrous dichloromethane under an argon atmosphere and dissolved with stirring. 20 g (viscosity 20-50 cSt) of dichlorosiloxane were initially charged in the dropping funnel and added dropwise at room temperature with vigorous stirring to the bisphenol TMC solution over the course of 50 minutes. Once the entirety of the siloxane derivative had been added, the mixture was stirred for a further 1 hour.

The solution was neutralized by dropwise addition of 1 M hydrochloric acid and adjusted to slightly acidic pH (pH<4); the solution was then transferred to a separating funnel and washed with demineralized water at least three times. If the solution was still distinctly acidic, the mixture was washed until the pH indicated an approximately neutral solution. The solvent was removed on a rotary evaporator to leave behind a suspension. The crude product was taken up in n-hexane, leaving behind the excess BP-TMC as a solid, and then dried over a molecular sieve (4 A) and filtered. The solution was concentrated as far as possible at <1 mbar and 50° C. for at least 0.5 h and filtered through a 5 m Teflon filter. This afforded a colourless oil.

NMR: ¹H NMR (Bruker AV III HD 600 MHz NMR spectrometer; CDCl₃): 7.19 (m, 2.0 H), 7.0 (m, 2.09 H), 6.80 (m, 1.1 H), 6.73 (m, 2.1 H), 6.65 (m, 0.9 H), 2.61 (m, 1.0 H), 2.37 (m, 1.0 H), 2.0-1.88 (m, 2.0 H), 1.36 (m, 1.0 H), 1.14 (m, 1.0 H), 0.97 (m, 6.0 H), 0.86 (m, 1.0 H), 0.36 ppm (m, 3.0 H), 0.25-0.20 (m, 7.2 H), 0.1-0.0 (m, 98.7 H).

This afforded a polysiloxane of formula (1A) where all R₁=methyl, n=about 30 and m=about 1.2.

### Example 3 (Comparative Example; Production of Si-Containing Block Co-Condensate Using a BPA-Terminated Siloxane According to Ex 1)

47.5 g of PC-1 were initially charged in a 250 m1 glass flask fitted with a stirrer, dropping funnel and short path separator. 2.5 g of polydimethylsiloxane from Example 1 (5% by weight) containing about 2 ppm of sodium (in the form of 0.036 mg of sodium 2-ethylhexanoate) were initially charged in the dropping funnel. The apparatus was evacuated and inertized with nitrogen (3× in each case). The PC-1 was melted at atmospheric pressure (under nitrogen) over 5 minutes using a metal bath preheated to 350° C. Vacuum was then applied. This was followed by rapid dropwise addition of the siloxane catalyst mixture at 100 mbar. The pressure was then reduced to the technically possible minimum which should be <1 mbar and the mixture was stirred at this pressure for 15 minutes. The mixture was subsequently inertized with nitrogen and the polymer melt withdrawn. This afforded a very hazy to opaque polymer. The solution viscosity was 1.470.

### Example 4 (Inventive Example; Production of Si-Containing Block Co-Condensate Using a TMC-Terminated Siloxane According to Example 2)

47.5 g of PC-1 were initially charged in a 250 m1 glass flask fitted with a stirrer, dropping funnel and short path separator. 2.5 g of polydimethylsiloxane from Example 2 (5% by weight) containing about 2 ppm of sodium (in the form of 0.036 mg of sodium 2-ethylhexanoate) were initially charged in the dropping funnel. The apparatus was evacuated and inertized with nitrogen (3× in each case). The PC-1 was melted at atmospheric pressure (under nitrogen) over 5 minutes using a metal bath preheated to 350° C. Vacuum was then applied. This was followed by rapid dropwise addition of the siloxane catalyst mixture at 100 mbar. The pressure was then reduced to the technically possible minimum, which should be <1 mbar, to about 1 mbar and the mixture was stirred at this pressure for 15 minutes. The mixture was subsequently inertized with nitrogen and the polymer melt withdrawn. This afforded a slightly hazy polymer. The solution viscosity was 1.436.

AFM Analysis with Evaluation of Volume Fraction of Siloxane Domains

TABLE 1

| | Volume fraction in the range | | | |
|---|---|---|---|---|
| | 0-50 nm | 50-100 nm | 100-200 nm | D90 |
| Ex. 3 | 13% | 76% | 11% | 79 nm |
| (comparative) | | | | |
| Ex. 4 (inventive) | 95% | 5% | 0% | 39 nm |

It is clearly apparent that the distribution in the inventive example is finer.

### Elugrams (GPC Analysis; Acetone Extract)

To determine the incorporation behaviour, the respective polymers were dissolved in dichloromethane and precipitated in acetone with stirring (ratio 1 part dichloromethane solution to 10 parts acetone). The precipitated polymer was separated by filtration and the mother liquor was concentrated to dryness.

A GPC with triple detection was recorded from the acetone extract (soluble proportion, mother liquor); in addition to the UV signal (black curve), the siloxane signal of the Si—O bands at about 1050 cm (light-grey curve) was also detected by IR detector.

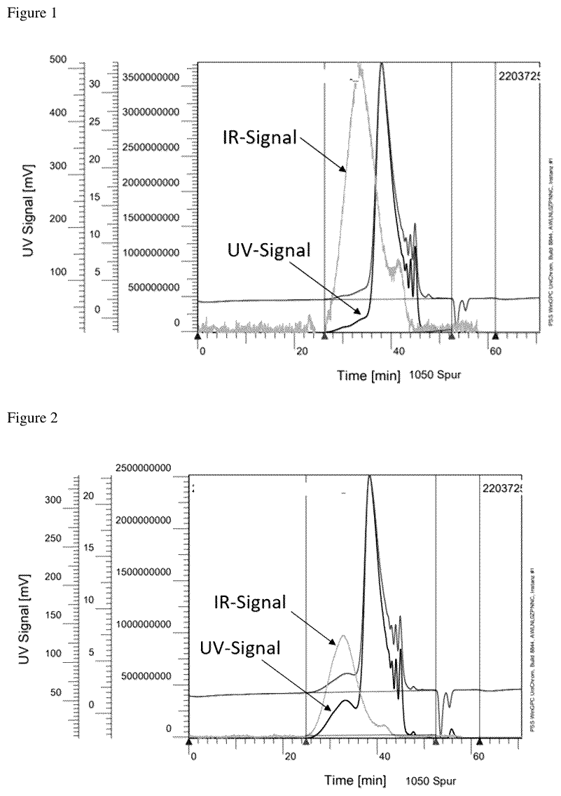

The result for Example 3 is shown in FIG. 1. The result for Example 4 is shown in FIG. 2. It is apparent from FIGS. 1 and 2 that basically 2 curves are detected in the elugram. Here, the black or mid-grey curve corresponds to the polycarbonate fraction which is soluble in acetone. These are especially polycarbonate oligomers having a molecular weight between 0 and 10 000 g/mol. This proportion consists almost exclusively of polycarbonate.

The light-grey curve describes the proportion of polydimethylsiloxane in particular. In the block co-condensate according to Example 3 (FIG. 1), the polycarbonate proportion in these chains is very low (see black curve); by contrast in the block co-condensate according to Example 4 (FIG. 2), the proportion of polycarbonate in the predominantly polydimethylsiloxane-based chains is significantly greater. It must be assumed that this improves the compatibility between polydimethylsiloxane and polycarbonate.

1. A process for producing a polysiloxane-polycarbonate block co-condensate by reaction of at least one polysiloxane of formula (1) 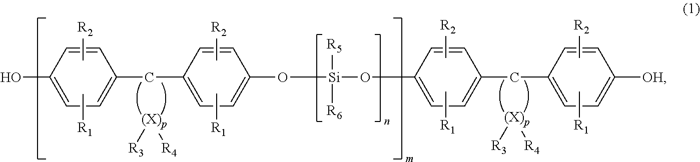
wherein each R₁ and R₂ independently represents hydrogen, halogen, C₁-C₆-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and X represents carbon,
each R₅ and R₆ independently represents an aliphatic or an aromatic group,
n is an average number of repeating units from 10 to 400, and
m is an average number of repeating units from 1 to 10,
(i) with at least one compound of formula (2) and/or (2I) in the presence of at least one base and phosgene in the interfacial process,
(ii) with at least one compound of formula (2) and at least one diaryl carbonate in the melt transesterification process or
(iii) with at least one compound of formula (2II) and optionally at least one diaryl carbonate in the melt transesterification process,
wherein 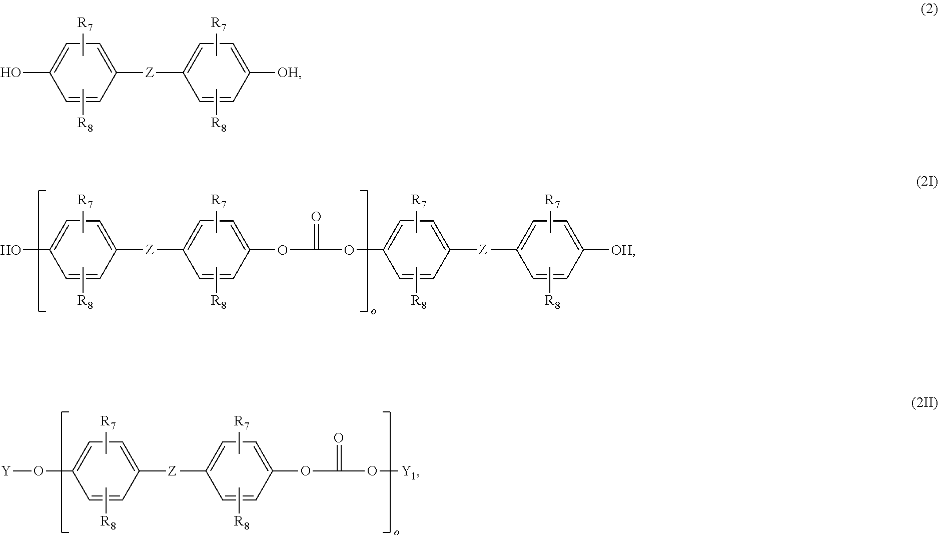
wherein each Z in formula (2), (2I) or (2II) is independently a single bond, —S(═O)₂—, —C(═O)—, —O—, —S—, —S(═O)—, —CH(CN)— or a linear or branched C₁-C₆-alkylene group which may optionally comprise at least one carbonyl group, may optionally comprise at least one halogen atom and/or which may optionally be interrupted by at least one heteroatom or a C₂-C₁₀-alkylidene group which may optionally comprise at least one carbon-carbon double bond, may optionally comprise at least one carbonyl group and/or may optionally comprise at least one halogen atom, each R₇ and R₈ in formula (2), (2I) or (2II) independently represents hydrogen, halogen, C₁-C₈-alkyl, C₅-C₆-cycloalkyl, C₁-C₄-alkoxy, phenyl or C₇-C₁₂-aralkyl,
o in formula (2I) or (2II) represents the average number of repeating units and may be 2 to 40,
Y in formula (2II) represents hydrogen or —(C═O)—O-Ph, wherein Ph represents an optionally substituted phenyl and
Y₁ in formula (2II) represents optionally substituted phenyl or a compound of formula (2IIa), wherein 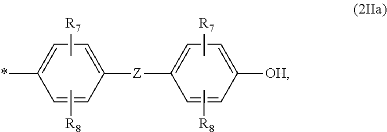
wherein each Z, R₇ and R₈ is as defined above for formula (2II) and “*” represents the site at which the structure of formula (2IIa) links to formula (2II) as Y₁.

2. The process according to claim 1, wherein each Z in formula (2), (2I) or (2II) is independently a single bond or isopropylidene and
each R₇ and R₈ in formula (2), (2I) or (2II) independently represents hydrogen or methoxy.

3. The process according to claim 1, wherein the polysiloxane of formula (1) is reacted (iii) with at least one compound of formula (2II) in the melt transesterification process.

4. The process according to claim 1, wherein the compound of formula (2II) has a relative solution viscosity eta rel of 1.08 to 1.22.

5. The process according to claim 1, wherein the reaction according to (i) to (iii) is carried out in the presence of at least one catalyst.

6. The process according to claim 1, wherein at east 50% by volume of a siloxane domains in the siloxane domain distribution of the polysiloxane-polycarbonate block co-condensate are in a range from greater than 0 to 50 nm, wherein the siloxane domain distribution is measured by atomic force microscopy.

7. A polysiloxane-polycarbonate block co-condensate comprising a Si—O—C bond, wherein at least 50% by volume of all siloxane domains in the siloxane domain distribution of the polysiloxane-polycarbonate block co-condensate are in a range from greater than 0 to 50 nm, wherein the siloxane domain distribution is measured by atomic force microscopy.

8. The polysiloxane-polycarbonate block co-condensate according to claim 7, wherein the polysiloxane-polycarbonate block co-condensate comprises structures of formula (1a) 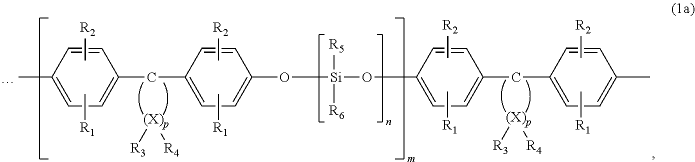
wherein each R₁ and R₂ independently represents hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and
X represents carbon,
each R₅ and R₆ independently represents an aliphatic or an aromatic group,
n is an average number of repeating units from 10 to 400,
m is an average number of repeating units from 1 to 10, and
“ . . . ” represents the sites at which the structure of formula (1a) is incorporated into the polysiloxane-polycarbonate block co-condensate.

9. The polysiloxane-polycarbonate block co-condensate according to claim 7, wherein the polysiloxane-polycarbonate block co-condensate comprises structures of formula (2a): 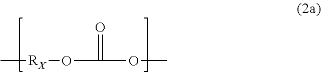
wherein each R_{X} is independently a divalent substituted or unsubstituted aromatic radical.

10. The polysiloxane-polycarbonate block co-condensate according to claim 9, wherein the structure of formula (2a) is represented by the structure of formula (2b) 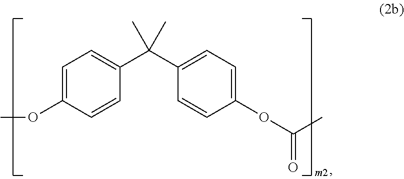
wherein m2 indicates the average number of repeating units.

11. The polysiloxane-polycarbonate block co-condensate according to claim 7, wherein the polysiloxane-polycarbonate block co-condensate has a weight-average molecular weight of 24 000 to 40 000 g/mol.

12. A moulding compound containing the polysiloxane-polycarbonate block co-condensate according to claim 7.

13. A moulded part containing the polysiloxane-polycarbonate block co-condensate according to claim 7.

14. A method for terminating a polysiloxane comprising providing a bisphenol of formula (3) 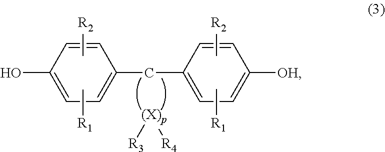
wherein R₁ and R₂ each independently represent hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and
X represents carbon,
wherein after reaction with the bisphenol of formula (3) the polysiloxane has at least one Si—O—C bond, to increase the reactivity of a terminated polysiloxane having an Si—O—C bond in the reaction with a bisphenol, oligocarbonate and/or polycarbonate.

15. A method for production of a polysiloxane-polycarbonate block co-condensate to increase the proportion of covalent bonds between the siloxane blocks and the polycarbonate blocks, wherein the polysiloxane has at least one Si—O—C bond, the method comprising providing a polysiloxane of formula (1) 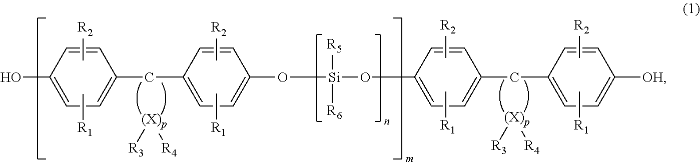
wherein each R₁ and R₂ independently represents hydrogen, halogen, C₁-C₈-alkyl, C₅-C₆-cycloalkyl, phenyl or C₇-C₁₂-aralkyl,
R₃ and R₄ are individually selectable for each X and independently represent hydrogen or C₁-C₆-alkyl, p is an integer from 4 to 7 and X represents carbon,
each R₅ and R₆ independently represents an aliphatic or an aromatic group,
n is an average number of repeating units from 10 to 400, and
m is an average number of repeating units from 1 to 10.
